(19) United States
(12) Patent Application Publication
(10) Pub. No.: US 2013/0130220 A1
(43) Pub. Date: May 23, 2013

(54) PRINTED ARTICLE COMPRISING AN ELECTRONIC DEVICE

(71) Applicant: Kate Jessie Stone, Cambridge (GB)

(72) Inventor: Kate Jessie Stone, Cambridge (GB)

(21) Appl. No.: 13/582,418

(22) PCT Filed: Mar. 2, 2011
(86) PCT No.: PCT/GB11/50413

§ 371 Date: Oct. 12, 2012

(30) Foreign Application Priority Data
Mar. 3, 2010 (GB) 1003536.8

(51) Int. Cl. G09B 7/00

(52) U.S. Cl. CPC G09B 7/00
USPC 434/362

(57) ABSTRACT

An article (1) includes a substrate (5) having indicia (6) printed thereon and an electronic device (2) having at least one input device (3) and at least one output device (4). The indicia (6) include one or more directions or questions (61) in response to which a user provides input to the electronic device via the at least one input device. The indicia further include a link (62) to a source of additional directions or questions.

### FIELD OF THE INVENTION

The present invention relates to a printed article.

### SUMMARY

According to a first aspect of the present invention there is provided an article comprising a substrate having indicia printed thereon and an electronic device having at least one input device and at least one output device. The indicia include direction(s) or question(s) in response to which a user provides input to the electronic device via the at least one input device. The indicia further include a link to a source of additional direction(s) or question(s). Thus, the user is provided with an incentive to visit the source, for example a web site, thereby allowing an entity hosting the source to market further products or services to the user.

At least a portion of the electronic device may comprise conductive tracks printed on the substrate. At least a portion of the electronic device may include components, at least one of which is printed on the substrate. For example, the at least one component can be a switch, resistor, capacitor, inductance, transistor or the like. Thus, at least part of the electronic device can be incorporated or integrated into the article.

The at least one input device may comprise a plurality of switches. The at least one input device may comprise one or more proximity-sensing input devices. The at least one output device include at least one sound-emitting device, for example one or more speakers, and/or at least one light-emitting device, for example one or more light-emitting diodes.

The direction(s) or instruction(s) may comprise a musical notation. The musical notation can be simplified, e.g. using colours, letters and/or numbers, to allow a user who is cannot read (five-stave-based) sheet music. The direction(s) or instruction(s) may comprise one or more quiz questions.

The link may comprise a uniform resource identifier (URI), such as a web address.

The electronic device may be a musical instrument, such as an electronic piano.

The article may comprise packaging for a product, e.g. a cereal packet, a tissue box or DVD case. The packaging may be primary, secondary or tertiary packaging. The article may comprise printed matter, such as a book, poster, display or promotional item.

According to a second aspect of the present invention there is provided a method of using the article, the method comprising providing input to the electronic device via the at least one input device including following the direction(s) or question(s), obtaining additional direction(s) or question(s) by following the link to a source of additional direction(s) or question(s) and providing additional input to the electronic device via the at least one input device by following the additional direction(s) or question(s).

Obtaining additional direction(s) or question(s) may comprise displaying the additional direction(s) or question(s). Obtaining the additional direction(s) or questions may comprise printing the additional direction(s) or question(s).

The method may further comprise activating the electronic device via a non-reversible modification of the article, e.g. pulling a tab or pressing a single-use blister contact, thereby connecting a battery the electronic device.

The method may further comprise detaching, from the article, a portion of the substrate on which the instruction(s) or question(s) are printed.

### BRIEF DESCRIPTION OF THE DRAWINGS

Certain embodiments of the present invention will now be described, by way of example, with reference to the accompanying drawings in which:

FIG. 1 shows an article and a system for obtaining additional material which a user can use to interact with the article;

FIGS. 2a and 2b are perspective views of the front and back of an example of an article; and

FIG. 3 is a process flow diagram of a method of obtaining additional material.

### DETAILED DESCRIPTION OF CERTAIN EMBODIMENTS

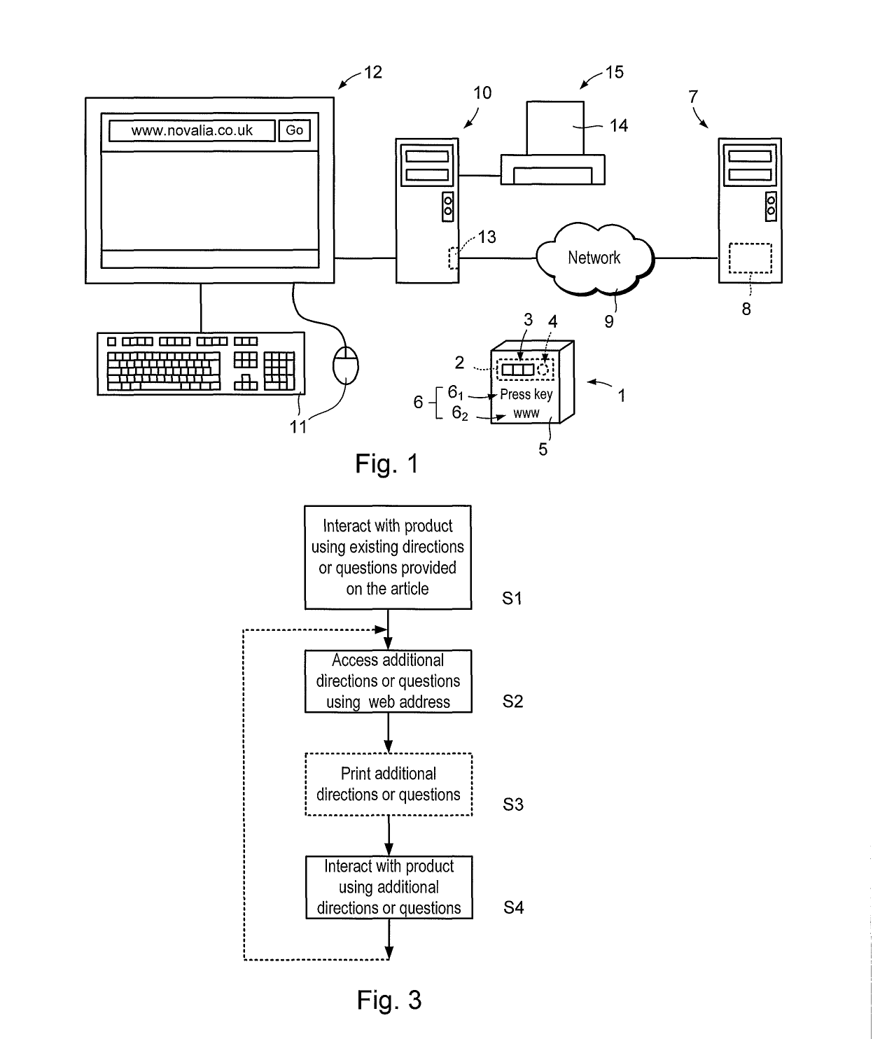

Referring to FIG. 1, an article 1 is shown which is enhanced with an electronic device 2 having at least one input device 3 and at least one output device 4 providing a user interface which allows a user (not shown) to interact with the article 1. The article 1 comprises a substrate 5, e.g. card, on which indicia 6 are printed. The indicia 6 include one or more directions or questions 6, in response to which the user can provide input to the electronic device 2 via the at least one input device 3. The indicia 6 also include a link 6₂, for example in the form of a web address, to a source 7 of one or more additional directions or questions 8. Herein, directions or questions 8 can also be referred to as “material”.

The user 1 can access the source 7 of additional material via a computer network 9, such as the Internet, using a computing device 10, such a desktop computer, having one or more input devices 11, such as a keyboard and mouse, a display 12 and a network interface 13. The computing device 10 may also have a printer 14 for printing additional material on print media 15.

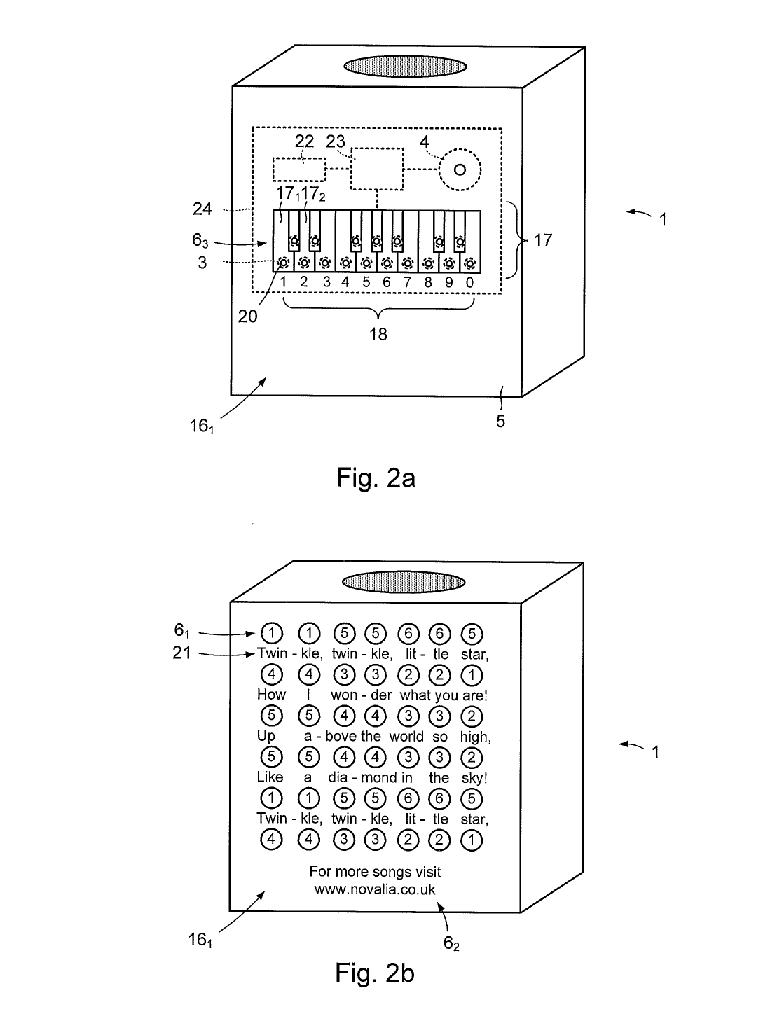

Referring to FIGS. 2a and 2b, an example of an article 1 is shown in more detail. In this example, the article 1 takes the form of a tissue box and the electronic device 2 is an electronic piano. However, different combinations of article 1 and electronic device 2 can be used.

As shown in FIG. 2a, on a first portion 16₁ of the box 1 (e.g. front face), the indicia 6 (FIG. 1) include a picture 6₃ of a piano keyboard comprising a set of keys 17 covering just over an octave. The keys 17 are marked with identifiers 18, e.g. in the form of letters, numbers and/or colours. For example, the C note 17₁ can be marked with a “1”, the D note 17₂ can be marked with a “2” and so on. Additionally or alternatively, the C note 17₁ can be marked with a first colour, e.g. a red dot, the D note 17₂ can be marked with a second colour, e.g. an orange dot, and so on.

Pressing of the keys 17 of the keyboard is sensed by respective proximity sensing pads 3. For example, the pads may be arranged under the keys 17, e.g. on the other side of the substrate 5 (i.e. inside the box) or on another substrate 19 glued to the insider of the box. The box 5 includes holes 20 to allow the pads 3 supported on the other substrate 19 to be touched.

As shown in FIG. 2b, on another portion 16₂ of the box, the indicia 6 (FIG. 1) includes lyrics 21 to a song, such as the song “Twinkle twinkle little star”. The lyrics 21 are annotated with, in this case, numbers, corresponding to the piano keys 17 so as to provide directions 6₁ for playing the piano keyboard.

A web address 6₂ provides a link to web site where other lyrics can be displayed and, optionally, printed out. The portion 16₂ of the box may be detachable. For example, the portion of the box can have perforations (not shown) along the edge to enable the user to remove the lyrics.

The electronic device 2 includes a battery 22 and microcontroller 23 and has a piezoelectric speaker 4 as an output device. Light emitting diodes may also be provided. Thus, microcontroller 23 is programmed so that when the user presses a key 17 (FIG. 2a), it causes the speaker 4 to generate a corresponding musical note.

The proximity-sensing pads 3, speaker 4, battery 22 and microcontroller 23 are provided on a separate substrate 24, e.g. a printed wiring board, which is attached to the substrate 5 forming the article 1. The proximity-sensing pads 3 can be formed by printing conductive ink on the substrate 5 or on additional substrate 24. The electronic device 2 can be mounted on the substrate 5. Connections between substrates 5, 24 can be formed using electrically conductive glue or tape.

Referring to FIGS. 1 and 3, a method of using the article 1 is shown.

The user can employ the article 1 in a normal way, e.g. by taking tissues from the box. Additionally or alternatively, they can interact with the article 1 through the electronic device 2 (step S1). For example, following the directions 6₁ on the box, they can play music on the piano 2. Once they have followed the directions or answered the questions provided, they can follow the link 6₂ and access additional material 8 (step S2). Optionally, they can print out new directions or questions 8 (step S3). However, the user can simply display the additional directions or questions 8 using their computing device display 12. The user can interact with the article 1 following the new directions or answering new questions 8.

In some examples, the device 2 may need to be activated before use, e.g. to minimise power loss. For example, this may involve the user pulling a tab or pressing a single-use blister contact (not shown), thereby closing a switch (not shown) and connecting the battery 22 to the microcontroller 23.

As explained earlier, the article 1 provides an entity which hosts the web-site, e.g. the manufacturer or their agent, with additional marketing opportunities. In other words, the article 1 can help direct traffic to their web-site.

It will be appreciated that many modifications may be made to the embodiments hereinbefore described. For example, the computing device 10 can be a portable computing device, such as a laptop computer. The computing device 10 can be a hand-held computing device, such as a mobile phone.

The article 1 can be any form of packaging or printed matter, such as poster or book. The article 1 (i.e. the substrate 5) can be made from card, cardboard or plastic, such as polyurethane. The article 1 may comprise several substrates, e.g. a card box with a plastic window.

The article 1 can include more than one link 6₂. For example, the article 1 may present two or more different web addresses.

The electronic device 2 need not be a piano, but can be any form of musical instrument. The electronic device 2 can be a game, puzzle or quiz. The electronic device 2 can include an interface (not shown) for allowing material to be uploaded.

The article 1 may be packaging for a product or a game, a book, a poster, a file or folder, or any other form of printed matter.

The article 1 may include more than one electronic device 2, e.g. game and an instrument. The article 1 and the electronic device 2 can inter-related. For example, the article 1 can be a game (e.g. a board game) and the electronic device 2 can form part of the game (e.g. a controller).

1. An article comprising:
a substrate having indicia printed thereon; and
an electronic device having at least one input device and at least one output device,
the indicia including directions or questions in response to which a user provides input to the electronic device via the at least one input device, the indicia further including a link to a source of additional directions or questions.

2. An article according to claim 1, wherein at least a portion of the electronic device comprises conductive tracks printed on the substrate.

3. An article according to claim 1, wherein at least a portion of the electronic device includes components, at least one of the components printed on the substrate and, optionally, the at least one component a switch and/or a transistor.

4. An article according to claim 1, wherein the at least one input device comprises a plurality of switches.

5. An article according to claim 1, wherein the at least one input device comprises at least one proximity-sensing input device.

6. An article according to claim 1, wherein the at least one output device includes at least one sound-emitting device, for example including speaker(s), and/or at least one light-emitting device, for example, for example at least one light-emitting diode.

7. An article according to claim 1, wherein the directions or instructions comprise music or quiz questions.

8. An article according to claim 1, wherein the link comprises a uniform resource identifier (URI), such as a web address.

9. An article according to claim 1, wherein the electronic device is a musical instrument, such as an electronic piano.

10. An article according to claim 1, wherein the article comprises packaging for a product.

11. An article according to claim 1, wherein the article comprises printed matter, such as a poster or book.

12. A method of using an article according to claim 1, the method comprising:
providing input to the electronic device via the at least one user input device by following the directions or answering the questions;
obtaining additional directions or questions by following the link to a source of additional directions or questions; and
providing additional input to the electronic device by following the additional directions or answering the additional questions.

13. A method according to claim 12, wherein obtaining additional directions or questions comprises displaying the additional directions or questions.

14. A method according to claim 12, wherein obtaining the additional directions or questions comprises printing the additional directions or questions.

15. A method according to claim 12 further comprising:
activating the electronic device.

16. A method according to claim 12, further comprising:
detaching a portion of the substrate on which the instructions or questions are printed from the article.
